(19) United States
(12) Patent Application Publication
(10) Pub. No.: US 2015/0027254 A1
(43) Pub. Date: Jan. 29, 2015

(54) Motor Vehicle Drive Train Device Comprising a Multi-Group Transmission

(71) Applicant: Daimler AG, Stuttgart (DE)

(72) Inventors: Manfred Guggolz, Leonberg (DE); Juergen Hertlein, Weinstadt (DE); Werner Hillenbrand, Neuffen (DE); Steffen Keppeler, Bibertal/Silheim (DE); Markus Stein, Stuttgart (DE); David Ulmer, Schoenaich (DE)

(73) Assignee: Daimler AG, Stuttgart (DE)

(21) Appl. No.: 14/384,107

(22) PCT Filed: Feb. 1, 2013
(86) PCT No.: PCT/EP2013/000306

§ 371 Date: Sep. 9, 2014

(30) Foreign Application Priority Data
Mar. 21, 2012 (DE) 10 2012 005 676.1

(51) Int. Cl. F16H 3/02; F16H 61/02

(52) U.S. Cl. CPC F16H 3/02; F16H 61/0293
USPC 74/335

(57) ABSTRACT

A motor vehicle drive train device includes a multi-group transmission with a main group providing at least one forward transmission gear and at least one reverse transmission gear, and a downstream group downstream from the main group. The device also includes a control and/or regulation unit having a gear change function for shifting the main group at least in one transmission gear change operation in order to engage a transmission gear opposite to the current direction of travel. The control and/or regulation unit has a synchronization function which is provided for shifting the downstream group in order to engage the transmission gear opposite to the current direction of travel.

### BACKGROUND AND SUMMARY OF THE INVENTION

Exemplary embodiments of the invention relate to a motor vehicle drive train device.

German patent document DE 10 2 49 952 A1 discloses a motor vehicle drive train device having a multi-group transmission, which includes a main group for providing a forward transmission gear and a reverse transmission gear, and a downstream group downstream from the main group, and a control and/or regulation unit having a gear change function which is provided for shifting the main group in a transmission gear change operation.

Furthermore, German patent document DE 10 2009 056 793 A1 discloses a method for engaging a transmission gear opposite to a current direction of travel.

PCT patent document WO 2011/062544 A1 discloses a method for braking a main shaft in which a downstream group is shifted into a high position in order to brake the main shaft.

Exemplary embodiments of the present invention are directed to improving shifting of the transmission gear opposite to the current direction of travel. Specifically, exemplary embodiments of the invention are directed to a motor vehicle drive train device having a multi-group transmission that includes a main group for providing at least one forward transmission gear and at least one reverse transmission gear, and a downstream group downstream from the main group, and a control and/or regulation unit having a gear change function provided for shifting the main group at least in one transmission gear change operation in order to engage a transmission gear opposite to the current direction of travel.

In accordance with exemplary embodiments of the invention, the control and/or regulation unit has a synchronization function for shifting the downstream group in order to engage the transmission gear opposite to the current direction of travel. As a result, the main group may be synchronized by means of the downstream group during the transmission gear change operation in order to engage the transmission gear opposite to the current direction of travel, thus at least reducing rattling and/or “shift shock” and making it possible to increase comfort during direct engagement, and thus during direct shifting of the transmission gear opposite to the current direction of travel. A rotational speed adaptation between a main shaft of the main group and a further gear shaft, in particular a countershaft of the multi-group transmission, may be improved in a particularly cost-effective manner, so that a motor vehicle speed at which the direct engagement, and thus the direct shifting, of the transmission gear opposite to the current direction of travel is possible may be increased, at least without significant loss of comfort. The motor vehicle speed at which the direct engagement, and thus the direct shifting, of the transmission gear opposite to the current direction of travel is possible at least without significant loss of comfort may be increased by a spreading factor of the downstream group, thus making it possible to change the direction of travel from an idling speed. The change in the direction of travel direction may thus be simplified, for example for maneuvering a motor vehicle having the motor vehicle drive train device and/or for rocking free a motor vehicle that is stuck in mud, for example. Engaging the transmission gear opposite to the current direction of travel, and thus, shifting the transmission gear opposite to the current direction of travel, may thus be improved in a cost-effective manner.

A “gear change function” is understood in particular to mean a function that is provided for shifting a transmission gear. In order to synchronize the main group, the synchronization function advantageously shifts the downstream group to engage the transmission gear opposite to the current direction of travel.

A “transmission gear change operation” is understood in particular to mean an operation during travel, in particular rolling, of the motor vehicle in which, starting from an actual gear, i.e., preferably a transmission gear that is currently engaged, a shift is made to a target gear opposite to the actual gear, the operation advantageously being initiated by a driver of the motor vehicle and/or by the shifting instruction triggered by the control and/or regulation unit.

A “transmission gear opposite to the current direction of travel” is understood in particular to mean a target gear provided for a direction of travel that is oriented opposite to a direction of travel for which an actual gear, which is shifted when there is a request for the target gear, is provided. For an engaged forward transmission gear, and thus for forward travel, the transmission gear opposite to the current direction of travel is preferably provided as the reverse transmission gear, and for an engaged reverse transmission gear, and thus for reverse travel, the transmission gear opposite to the current direction of travel is preferably provided as the forward transmission gear.

The term “forward transmission gear” basically includes all forward transmission gears that are shiftable by means of the multi-group transmission, in particular a starting transmission gear which is provided for forward travel, and thus, a so-called first forward transmission gear.

The term “reverse transmission gear” basically includes all reverse transmission gears that are shiftable by means of the multi-group transmission, in particular a starting transmission gear that is provided for reverse travel. The transmission gear change operation during which the synchronization function shifts the downstream group is advantageously provided for a change in travel direction. The transmission gear change operation is preferably designed as a change in travel direction operation.

A “current direction of travel” is understood in particular to mean a direction of travel in which the motor vehicle is moving when the transmission gear change operation is initiated, and thus, during the shifting instruction and/or when the transmission gear is requested.

A “multi-group transmission” is understood in particular to mean a transmission that is composed of a combination of one-, two-, or multi-stage single gears.

A “main group” is understood in particular to mean a single gear intended to provide and/or set at least one forward transmission gear and at least one reverse transmission gear, and/or which has at least two settable gear ratios which are opposite one another, and which thus differ in their algebraic signs.

A “downstream group” is understood in particular to mean a single gear downstream from the main group that preferably provides at least two different gear ratios for increasing the number of gears, and/or which is intended for providing a fast transmission gear and a slow transmission gear provided by means of the main group. A gear ratio may preferably also have a value of 1. The downstream group is preferably designed as a range group.

The terms “upstream from” and “downstream from” are understood in particular to mean in relation to a flow of force that is present for drive wheels driven by the drive machine and/or for an active drive machine, i.e., which preferably provides drive torque, and which is in drive connection with the multi-group transmission.

The multi-group transmission is preferably designed as an unsynchronized gear, i.e., a gear that is free of synchronous elements. An “unsynchronized gear” is understood in particular to mean a gear which has positive-fit coupling units that are unsynchronized, i.e., free of synchronous elements, for engaging and/or for shifting the transmission gears. The coupling units are preferably designed as claw clutches or claw brakes which are unsynchronized, i.e., free of synchronous elements.

A “control and/or regulation unit” is understood in particular to mean a unit that includes at least one control device.

A “control device” is understood in particular to mean a unit having a processor unit and a memory unit as well as an operating program that is stored in the memory unit. In principle, the control and/or regulation unit may include multiple interconnected control devices which preferably are provided for communicating with one another via a bus system, such as a CAN bus system.

A “synchronization function” is understood in particular to mean a function provided for synchronizing the main group in the transmission gear change operation, and thus preferably for engaging the transmission gear opposite to the current direction of travel.

The term “synchronization of the main group” is understood in particular to mean adjustment of speed differences between the main shaft and the other gear shaft, preferably the countershaft.

The term “shifting the downstream group” is understood in particular to mean an actuation of the downstream group and/or a change of a shift position of the downstream group and/or a change of a gear ratio of the downstream group. The synchronization function advantageously changes a gear ratio within the downstream group during the transmission gear change operation in order to synchronize the main group. The synchronization function preferably shifts the downstream group prior to engaging the transmission gear opposite to the current direction of travel, and thus, prior to engaging the target gear.

The term “engaging a transmission gear” is understood in particular to mean setting a gear ratio associated with the corresponding transmission gear within the main group, and/or establishing a torque-transmitting connection between all coupling units of the main group which are provided for the corresponding transmission gear. A transmission gear is preferably engaged by the main group. The downstream group is advantageously provided for converting the engaged transmission gear of the main group.

The term “shifting a transmission gear” is understood in particular to mean setting a torque-transmitting connection between a drive machine and drive wheels of the motor vehicle when the target gear is engaged. An operation in which the transmission gear is shifted preferably constitutes an operation in which the transmission gear is engaged. The shifting of the transmission gear preferably constitutes disengagement of an actual gear, engagement of the corresponding target gear, in particular the transmission gear opposite to the current direction of travel, and lastly, engagement of a starting clutch for establishing the torque-transmitting connection between the drive machine and the drive wheels.

The term “provided” is understood in particular to mean specially programmed, designed, equipped, and/or situated.

Furthermore, in accordance with exemplary embodiments of the invention the main group has at least one main shaft, and the synchronization function is provided for shifting the downstream group to reduce the rotational speed of the main shaft in order to engage the transmission gear opposite to the current direction of travel, as the result of which the main group may be synchronized in a particularly simple manner. The main group is preferably designed as a countershaft.

In addition, the multi-group transmission has at least one shaft brake, and the synchronization function is provided for actuating the shaft brake in order to engage the transmission gear opposite to the current direction of travel. A rotational speed of the further gear shaft, in particular the countershaft, may thus be adapted to the rotational speed of the main shaft, so that the shifting of the transmission gear opposite to the current direction of travel may be further improved.

The term “actuating the shaft brake” is understood in particular to mean setting a brake force of the shaft brake to be greater than zero. The shaft brake is preferably designed as a countershaft brake. A “countershaft brake” is understood in particular to mean a shaft brake which is situated on the countershaft, and/or whose brake force brakes the countershaft.

In particular, it is advantageous when the multi-group transmission has a front-mounted group, and the gear change function is provided for shifting the front-mounted group into neutral during the transmission gear change operation, prior to engaging the transmission gear, as the result of which active mass moments of inertia may be reduced for engaging the transmission gear. A “front-mounted group” is understood in particular to mean a single gear situated upstream from the main group and which preferably provides at least two different gear ratios in order to increase the number of gears. A “front-mounted group shifted into neutral” is understood in particular to mean an actuation state of the front-mounted group in which torque transmission by the front-mounted group is prevented, for this purpose the front-mounted group preferably having a defined neutral position or being capable of being brought into a position in which the torque transmission is prevented. For a front-mounted group which is shifted into neutral, the main group is preferably drive-decoupled from a transmission input shaft. The front-mounted group is advantageously designed as a splitter group.

In addition, it is advantageous when the gear change function is provided for downshifting at least the downstream group during the transmission gear change operation, after engagement of the transmission gear. A particularly advantageous transmission gear may be shifted in this way. The term “downshifting the downstream group” is understood in particular to mean that the gear change function discontinues the shift position of the downstream group which is set by the synchronization function, and/or sets a shift position of the downstream group which differs from a shift position that is set by the synchronization function. The gear change function preferably sets a shift position of the downstream group, due to the downshifting of the downstream group, in which the downstream group has been shifted prior to the shifting by the synchronization function. The gear change function preferably downshifts the front-mounted group during the transmission gear change operation, after the engagement of the transmission gear and preferably after the downshifting of the downstream group.

In addition, it is advantageous when the motor vehicle drive train device has at least one rotational speed sensor having rotational direction recognition, the rotational speed sensor being in communicating connection with the control and/or regulation unit in order to recognize the current direction of travel and/or to adjust to a desired direction of travel. A particularly advantageous change in travel direction may be achieved in this way. The rotational speed sensor is preferably situated on a transmission output shaft.

Furthermore, the downstream group has a high position and a low position, and the synchronization function is provided for shifting the downstream group from the low position into the high position in order to engage the transmission gear opposite to the current direction of travel. In this way, use may be made of a gear ratio of the downstream group for synchronizing the main group. The term “high position” is understood in particular to mean a shift position of the downstream group in which a smaller gear ratio of the at least two gear ratios of the downstream group is set. The term “low position” is understood in particular to mean a shift position of the downstream group in which a larger gear ratio of the at least two gear ratios of the downstream group is set. The synchronization function preferably shifts the downstream group from the large gear ratio to the small gear ratio during the transmission gear change operation in order to synchronize the main group.

In particular, it is advantageous when the synchronization function is provided for shifting the downstream group into neutral in order to engage the transmission gear opposite to the current direction of travel. The motor vehicle speed at which the direct shifting of the transmission gear opposite to the current direction of travel is possible without at least significant loss of comfort may thus be further increased. The term “shifting the downstream group into neutral” is understood in particular to mean an actuation state of the downstream group in which transmission of torque by the downstream group is prevented, for this purpose the downstream group preferably having a defined neutral position or being capable of being brought into a position in which the transmission of torque is prevented. For a downstream group shifted into neutral, the main group is preferably drive-decoupled from the transmission output shaft. The synchronization function preferably shifts the downstream group either into the high position or into neutral in order to synchronize the main group.

Furthermore, it is advantageous when the main group is designed as an unsynchronized claw clutch transmission group. A cost-effective multi-group transmission may be provided in this way. A “claw clutch transmission group” is understood in particular to mean a single gear having coupling units designed as claw clutches and/or claw brakes for setting the corresponding gear ratios. For engaging the transmission gears, the main group advantageously has positive-fit claw clutches that are unsynchronized, i.e., free of synchronous elements, and which are preferably engaged and disengaged by means of a sliding sleeve.

Moreover, a method for engaging a transmission gear opposite a current direction of travel in a multi-group transmission of a motor vehicle drive train device, in particular a motor vehicle drive train device according to the invention, is proposed in which, at least in one transmission gear change operation, a main group is shifted for engaging the transmission gear opposite to the current direction of travel, the downstream group being shifted during the transmission gear change operation in order to engage the transmission gear opposite to the current direction of travel. The main group may thus be synchronized in a particularly cost-effective manner. During the transmission gear change operation, the downstream group is preferably shifted either into the high position or into neutral for engaging the transmission gear opposite to the current direction of travel.

Further advantages result from the following description of the drawings. One exemplary embodiment of the invention is illustrated in the drawings. The drawings, the description, and the claims contain numerous features in combination. Those skilled in the art will also advantageously consider the features individually and combine them into further meaningful combinations.

### BRIEF DESCRIPTION OF THE DRAWING FIGURES

The figures show the following:

FIG. 1 shows a schematic illustration of a motor vehicle drive train device having a multi-group transmission, and

FIG. 2 shows a schematic shift sequence for a transmission gear change during travel from a forward transmission gear into a reverse transmission gear.

### DETAILED DESCRIPTION

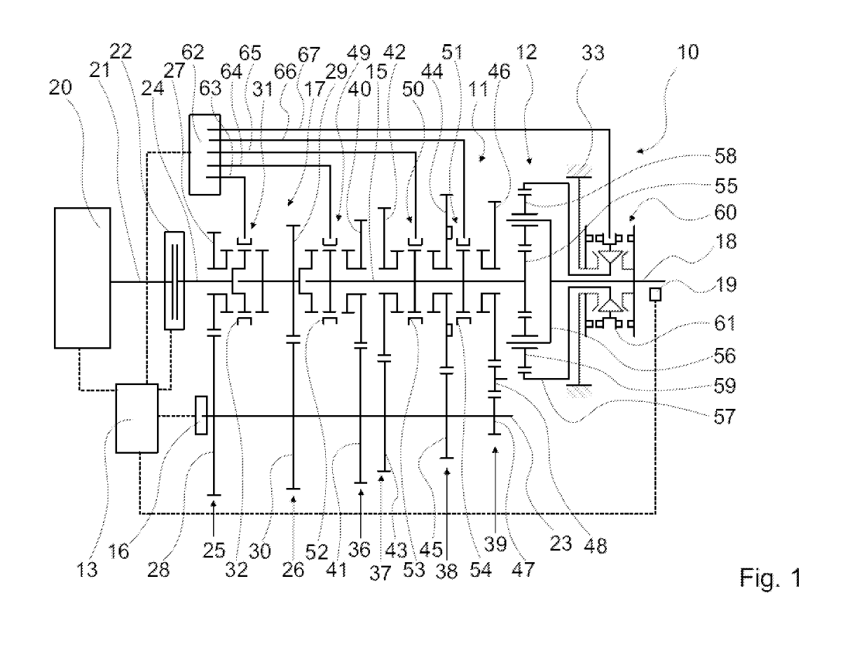

FIG. 1 schematically shows a motor vehicle drive train of a motor vehicle, not illustrated in greater detail, having a motor vehicle drive train device. The motor vehicle drive train device has a multi-group transmission 10 for setting multiple transmission gears. The multi-group transmission 10 provides 16 transmission gears. The motor vehicle drive train has a drive machine 20 for providing a drive torque. The drive machine 20 is situated upstream from the motor vehicle drive train device. In addition, the motor vehicle drive train has drive wheels, not illustrated in greater detail. The drive machine 20 is designed as an internal combustion engine. The motor vehicle is designed as a truck. The multi-group transmission 10 is designed as a truck transmission, which is an automatic transmission. The multi-group transmission 10 is designed as an unsynchronized claw transmission. In principle, as will be appreciated by those skilled in the art, the multi-group transmission 10 may also provide a different number of transmission gears—for example 12 transmission gears.

The motor vehicle drive train device has a drive shaft 21 for introducing the drive torque into the multi-group transmission 10. The drive shaft 21 connects the multi-group transmission 10 to the drive machine 20. The motor vehicle drive train device has a transmission output shaft 18 for leading out a drive torque that is converted by an overall gear ratio. The transmission output shaft 18 connects the multi-group transmission 10 to the drive wheels via an axle gear, not illustrated in greater detail. The motor vehicle drive train device has a rotational speed sensor 19 with rotational direction recognition for recognizing a current direction of travel and for adjusting to a desired direction of travel. The rotational speed sensor 19 is situated on the transmission output shaft 18, and detects a rotational speed and a rotational direction of the transmission output shaft 18.

The motor vehicle drive train device has a starting clutch 22 for establishing and separating a drive connection between the drive machine 20 and the multi-group transmission 10. The starting clutch 22 is designed as a multi-plate clutch. The starting clutch 22 has a disengaged state and an engaged state. In the disengaged state the starting clutch 22 is unpressurized. In the disengaged state of the starting clutch 22, the drive connection between the drive machine 20 and the multi-group transmission 10 is separated, and a drive torque cannot be transmitted from the drive machine 20 into the multi-group transmission 10. In the engaged state the starting clutch 22 is acted on by a pressure. The drive connection between the drive machine 20 and the multi-group transmission 10 is established in the engaged state of the starting clutch 22. The drive torque may be introduced by the drive machine 20 into the multi-group transmission 10. The drive machine 20 is situated upstream from the starting clutch 22.

The multi-group transmission 10 has a front-mounted group 17, a main group 11, and a downstream group 12. The front-mounted group 17 is situated upstream from the main group 11. The downstream group 12 is situated downstream from the main group 11. The main group 11 provides four different forward transmission gears and one reverse transmission gear. The main group 11 includes a gear shaft 23. The gear shaft 23 is designed as a countershaft. The gear shaft 23 is situated in parallel to the drive shaft 21. The main group 11 has a main shaft 15 which is situated coaxially with respect to the drive shaft 21. The main group 11 is designed as a main gear. The main shaft 15 is situated coaxially with respect to the transmission output shaft 18. The main group 11 is situated upstream from the drive wheels. The main group 11 is designed as a countershaft.

The front-mounted group 17 has a transmission input shaft 24 situated coaxially with respect to the drive shaft 21. The transmission input shaft 24 connects the multi-group transmission 10 to the starting clutch 22. The front-mounted group 17 is connectable to the main group 11 via the gear shaft 23. The front-mounted group 17 is situated downstream from the starting clutch 22. The front-mounted group 17 includes two different gearwheel pairs 25, 26 for providing an operative connection of the transmission input shaft 24 to the gear shaft 23. The gearwheel pairs 25, 26 have different gear ratios. The gearwheel pair 25 has an idler gear 27 rotatably mounted on the transmission input shaft 24, and a fixed gear 28 non-rotatably mounted on the gear shaft 23. The gearwheel pair 26 has an idler gear 29 rotatably mounted on the main shaft 15, and a fixed gear 30 non-rotatably mounted on the gear shaft 23. The front-mounted group 17 sets two front-mounted group gear ratios. The front-mounted group 17 converts a rotational speed of the drive machine 20, and selectively converts the rotational speed of the drive machine 20 to a faster speed or a slower speed. The front-mounted group 17 is designed as a splitter group.

The front-mounted group 17 has three shift positions: a high position, a low position, and a neutral position. In the high position, the front-mounted group 17 sets the smaller of the two front-mounted group gear ratios. In the high position, the front-mounted group 17 converts the rotational speed of the drive machine 20 into a faster speed. In the low position, the front-mounted group 17 sets the larger of the two front-mounted group gear ratios. In the low position, the front-mounted group 17 converts the rotational speed of the drive machine 20 into a slower speed. In the neutral position, the front-mounted group 17 prevents transmission of the drive torque into the main group 11. In the neutral position, the front-mounted group 17 separates the transmission input shaft 24 from the gear shaft 23 in terms of drive. In the neutral position, the front-mounted group 17 decouples the transmission input shaft 24 from the gear shaft 23.

The front-mounted group 17 has a front-mounted group shifting unit 31 for setting and for changing the front-mounted group gear ratio, and thus for shifting the front-mounted group 17. The front-mounted group shifting unit 31 has coupling units provided for establishing a torque-transmitting connection between the transmission input shaft 24 and the gear shaft 23 via the corresponding gearwheel pair 25, 26.

The front-mounted group shifting unit 31 has a first shift position, a second shift position, and a neutral position for shifting into the high position, the low position, and the neutral position, respectively. In the first shift position, the front-mounted group shifting unit 31 connects the idler gear 27 to the transmission input shaft 24 in a rotationally fixed manner. In the first shift position, the front-mounted group shifting unit 31 connects the transmission input shaft 24 to the gear shaft 23 in a torque-transmitting manner via the gearwheel pair 25. In the second shift position, the front-mounted group shifting unit 31 connects the idler gear 29 to the transmission input shaft 24 in a rotationally fixed manner. In the second shift position, the front-mounted group shifting unit 31 connects the transmission input shaft 24 to the gear shaft 23 in a torque-transmitting manner via the gearwheel pair 26. In the neutral position, none of the idler gears 27, 29 are connected to the transmission input shaft 24, and torque cannot be transmitted from the front-mounted group 17 to the gear shaft 23. The coupling units are designed as claw clutches. The front-mounted group shifting unit 31 has a shifting sleeve 32 for shifting the front-mounted group 17. The shifting sleeve 32 is axially displaceable with respect to the transmission input shaft 24. The front-mounted group shifting unit 31 is pressure-controlled. The front-mounted group 17 is pneumatically shiftable. In principle, the front-mounted group 17 may also have a hydraulically or electromechanically shiftable design.

The main group 11 includes four different gearwheel pairs 36, 37, 38, 39 for providing an operative connection of the main shaft 15 to the gear shaft 23. The gearwheel pairs 36, 37, 38, 39 have different gear ratios. The gearwheel pair 36 has an idler gear 40 rotatably mounted on the main shaft 15 and a fixed gear 41 non-rotatably mounted on the gear shaft 23. The gearwheel pair 37 has an idler gear 42 rotatably mounted on the main shaft 15 and a fixed gear 43 non-rotatably mounted on the gear shaft 23. The gearwheel pair 38 has an idler gear 44 rotatably mounted on the main shaft 15 and a fixed gear 45 non-rotatably mounted on the gear shaft 23. The gearwheel pair 39 has an idler gear 46 rotatably mounted on the main shaft 15, a fixed gear 47 non-rotatably mounted on the gear shaft 23, and a reverse gear 48, and is provided for forming the reverse transmission gear.

The main group 11 has three main group shifting units 49, 50, 51 for setting and for changing the main group gear ratio, and thus for shifting the main group 11. The two main group shifting units 49, 50 are provided for engaging the forward transmission gears, and the main group shifting unit 51 is provided for engaging the reverse transmission gear. The main group shifting units 49, 50 each have two shift positions and a neutral position. The main group shifting unit 51 has one shift position and a neutral position.

The main group shifting units 49, 50, 51 each have coupling units provided for establishing a torque-transmitting connection between the main shaft 15 and the gear shaft 23 via the corresponding gearwheel pair 36, 37, 38, 39. The main group shifting units 49, 50, 51 are each unsynchronized. The coupling units are designed as unsynchronized claw clutches. The main group 11 is designed as an unsynchronized claw clutch transmission group. Each main group shifting unit 49, 50, 51 has a shifting sleeve 52, 53, 54, respectively, for shifting the main group 11. The shifting sleeve 52 is associated with the main group shifting unit 49, the shifting sleeve 53 is associated with the main group shifting unit 50, and the shifting sleeve 54 is associated with the main group shifting unit 51. The shifting sleeves 52, 53, 54 are each axially displaceable with respect to the main shaft 15. The main group shifting units 49, 50, 51 are each pressure-controlled. The main group 11 is pneumatically shiftable. In principle, the main group 11 may also have a hydraulically or electromechanically shiftable design.

The downstream group 12 has a planet wheel design. The downstream group 12 has a sun wheel 55, a planet carrier 56, and an internal gear 57. Planet wheels 58, 59, which mesh with the sun wheel 55 and with the internal gear 57, are rotatably mounted on the planet carrier 56. For driving the downstream group 12, the sun wheel 55 is connected to the main shaft 15 of the main group 11 in a rotationally fixed manner. An output is achieved via the planet carrier 56. The planet carrier 56 is connected to the transmission output shaft 18 in a rotationally fixed manner. The internal gear 57 is intended for providing a downstream group gear ratio.

The downstream group 12 sets two downstream group gear ratios. The downstream group 12 converts the transmission gears that are engaged within the main group 11. The downstream group selectively converts the transmission gears engaged within the main group 11 to a faster speed or a slower speed. The downstream group 12 is designed as a range group. The downstream group 12 has three shift positions: a high position, a low position, and a neutral position. In the high position, the downstream group 12 sets the smaller of the two downstream group gear ratios. In the high position, the downstream group 12 converts the transmission gear that is engaged within the main group 11 to a faster speed. In the low position, the downstream group 12 sets the larger of the two downstream group gear ratios. In the low position, the downstream group 12 converts the transmission gear that is engaged within the main group 11 to a slower speed. In the neutral position, the downstream group 12 prevents transmission of the drive torque to the transmission output shaft 18. In the neutral position, the downstream group 12 separates the main shaft 15 from the transmission output shaft 18 in terms of drive. In the neutral position, the downstream group 12 decouples the main shaft 15 from the transmission output shaft 18. In the high position, the downstream group 12 has a downstream group gear ratio of 1. In the low position, the downstream group 12 has a downstream group gear ratio of 4.4.

The downstream group 12 has a downstream group shifting unit 60 for setting and for changing the downstream group gear ratio, and thus for shifting the downstream group 12. For shifting the high position, the low position, and the neutral position, the downstream group shifting unit 60 has a first shift position, a second shift position, and a neutral position, respectively. In the first shift position, the downstream group shifting unit 60 connects the internal gear 57 to a gearbox 33 in a rotationally fixed manner. In the second shift position, the downstream group shifting unit 60 connects the internal gear 57 to the transmission output shaft 18 in a rotationally fixed manner. In the second shift position, the sun wheel 55 rotates at the same speed as the planet carrier 56. In the second shift position, the downstream group 12 is shifted into the high position. The transmission output shaft 18 thus has the same rotational speed as the main shaft 15. In the neutral position, the internal gear 57 is freely rotatable, and torque cannot be transmitted from the downstream group 12 to the transmission output shaft 18. The downstream group shifting unit 60 has a shifting element 61 for shifting the downstream group 12. The shifting element 61 is axially displaceable with respect to the transmission output shaft 18. The downstream group shifting unit 60 is pressure-controlled. The downstream group 12 is pneumatically shiftable. In principle, the downstream group 12 may also have a hydraulically or electromechanically shiftable design. In principle, the downstream group 12 may also have a front-mounted design.

The motor vehicle drive train device has an actuating unit 62 for axially moving the shifting sleeves 32, 52, 53, 54 and the shifting element 61, and thus for shifting the front-mounted group 17, the main group 11, and the downstream group 12. The actuating unit 62 is pressure-controlled. The actuating unit 62 has five shift rods 63, 64, 65, 66, 67. The shift rod 63 moves the shifting sleeve 32, the shift rod 64 moves the shifting sleeve 52, the shift rod 65 moves the shifting sleeve 53, the shift rod 66 moves the shifting sleeve 54, and the shift rod 67 moves the shifting element 61. The actuating unit 62 has five actuating devices, not illustrated in greater detail, for the pressure-controlled movement of the shift rods 63, 64, 65, 66, 67, each actuating device being provided for moving one shift rod 63, 64, 65, 66, 67. The actuating devices are designed as pneumatic actuating devices. In principle, the actuating unit 62 may also have a different number of actuating devices which appears meaningful to those skilled in the art.

Sixteen different forward transmission gears having different gear ratios are shiftable by means of the front-mounted group 17, the main group 11, and the downstream group 12. Eight forward transmission gears are provided by engaging four different forward transmission gears within the main group 11 and converting the rotational speed of the drive machine 20 within the front-mounted group 17. The number of available forward transmission gears is doubled due to the downstream group 12 situated downstream. The first eight forward transmission gears are provided by shifting the downstream group 12 into the high position. The forward transmission gears 9 through 16 are provided by shifting the downstream group 12 into the low position. In addition, two different reverse transmission gears having different gear ratios are shiftable by means of the front-mounted group 17, the main group 11, and the downstream group 12. Two reverse transmission gears are provided by engaging a reverse transmission gear within the main group 11 and converting the rotational speed of the drive machine 20 within the front-mounted group 17. The reverse transmission gears are meaningful only when the downstream group 12 is shifted into the high position.

The multi-group transmission 10 also has a mechanical shaft brake 16. The shaft brake 16 is provided for synchronizing the gear shaft 23. The shaft brake 16 is situated on the gear shaft 23, and is provided for braking the gear shaft 23. The shaft brake 16 is provided for generating a brake force which acts on the gear shaft 23. The shaft brake 16 is pneumatically actuatable. The shaft brake 16 is designed as a front-mounted shaft brake. In principle, the shaft brake 16 may also be hydraulically or electromechanically actuatable.

The motor vehicle drive train device has a control and regulation unit 13 for setting and for changing the overall gear ratio, and thus for shifting the front-mounted group 17, the main group 11, and the downstream group 12. The control and regulation unit 13 is in communicating connection with the drive machine 20, the actuating unit 62, the starting clutch 22, the shaft brake 16, and the rotational speed sensor 19. The control and regulation unit 13 has a gear change function for shifting a transmission gear. The gear change function shifts the front-mounted group 17, the main group 11, and/or the downstream group 12 in a transmission gear change operation. The gear change function shifts the main group 11 for engaging a forward transmission gear or a reverse transmission gear. For shifting the front-mounted group 17, the main group 11, and the downstream group 12, the control and regulation unit 13 actuates the front-mounted group shifting unit 31, the particular main group shifting unit 49, 50, 51, and/or the downstream group shifting unit 60, respectively, by controlling the corresponding actuating device.

In a transmission gear change operation 14, the gear change function shifts the main group 11 in order to engage a transmission gear opposite to a current direction of travel. The engagement of the transmission gear opposite to the current direction of travel takes place by shifting the main group 11. For shifting the transmission gear opposite to the current direction of travel, the gear change function engages the transmission gear opposite to the current direction of travel within the main group 11. A change in travel direction may take place only by shifting the main group 11. The gear change function controls the actuating unit 62 in order to shift the transmission gears. The gear change function actuates the front-mounted group shifting unit 31, the main group shifting units 49, 50, 51, and the downstream group shifting unit 60 by means of the actuating unit 62. The control and regulation unit 13 recognizes the current direction of travel by means of the rotational speed sensor 19. The control and regulation unit 13 utilizes the rotational speed sensor 19 in order to adjust to a desired direction of travel, i.e., a direction of travel after a change in travel direction.

The control and regulation unit 13 has a synchronization function for synchronizing the main group 11 during the transmission gear change operation 14 in which the transmission gear opposite to the current direction of travel is shifted. The synchronization function is provided for synchronizing the main shaft 15 with the gear shaft 23. For shifting the transmission gear opposite to the current direction of travel, the gear change function engages the transmission gear opposite to the current direction of travel by means of the main group 11. For engaging the transmission gear opposite to the current direction of travel, the synchronization function synchronizes the main group 11 during the transmission gear change operation 14 by shifting the downstream group 12. The term “engaging a transmission gear” is understood in particular to mean setting the main group gear ratio within the main group 11, and preferably not setting the front-mounted group gear ratio and the downstream group gear ratio. The direction of travel is defined by the engagement of the transmission gear. For forward travel of the motor vehicle, and thus with an engaged forward transmission gear, the transmission gear opposite to the current direction of travel is provided as the reverse transmission gear. The forward travel is provided as forward rolling. For reverse travel of the motor vehicle, and thus with an engaged reverse transmission gear, the transmission gear opposite to the current direction of travel is provided as the forward transmission gear. The reverse travel is provided as backward rolling.

For engaging the transmission gear opposite to the current direction of travel, during the transmission gear change operation 14 the synchronization function shifts the downstream group 12 in order to synchronize the main group 11. The synchronization function shifts the downstream group 12 in the transmission gear change operation 14 in which the gear change function shifts the main group 11 in order to engage a transmission gear opposite to the direction of travel. The synchronization function shifts the downstream group 12 for engaging the transmission gear opposite to the current direction of travel. The synchronization function shifts the downstream group 12 prior to engagement of the transmission gear opposite to the current direction of travel, and thus, prior to the engagement of a target gear.

In order to synchronize the main group 11, the synchronization function shifts the downstream group 12 contrary to a desired transmission gear. The shifting of the downstream group 12 is thus contrary to the actual desired transmission gear. For shifting the downstream group 12, the synchronization function actuates the downstream group shifting unit 60. During shifting of the downstream group 12, the synchronization function changes the shift position of the downstream group 12 in order to synchronize the main group 11 for engaging the transmission gear opposite to the current direction of travel.

For engaging the transmission gear opposite to the current direction of travel, during the transmission gear change operation 14 the synchronization function shifts the downstream group 12 to reduce the rotational speed of the main shaft 15. During the transmission gear change operation 14, the synchronization function shifts the downstream group 12 to brake the main shaft 15. The synchronization function shifts the downstream group 12 into a shift position by means of which the downstream group 12 brakes and thus synchronizes the main shaft 15. During the transmission gear change operation 14, the synchronization function shifts the downstream group 12 after disengagement of the currently engaged transmission gear, and thus, after disengagement of the actual gear. During the transmission gear change operation 14, the synchronization function shifts the downstream group 12 when the main group 11 is shifted into neutral. For synchronizing the main group 11, the synchronization function shifts the downstream group 12 when all main group shifting units 49, 50, 51 are shifted into the neutral position.

The synchronization function shifts the downstream group 12 into the high position in order to brake the main shaft 15. For synchronizing the main group 11, the synchronization function shifts the downstream group 12 from the low position into the high position. The synchronization function sets the second shift position of the downstream group shifting unit 60. During the transmission gear change operation 14, for synchronizing the main group 11 the synchronization function, starting from the first shift position of the downstream group shifting unit 60, sets the second shift position of the downstream group shifting unit 60.

For braking the gear shaft 23, the synchronization function controls the shaft brake 16 during the transmission gear change operation 14. For braking the gear shaft 23, the synchronization function controls the shaft brake 16 after the disengagement of the current engaged transmission gear, and thus, after the disengagement of the actual gear. The synchronization function sets a brake force that acts on the gear shaft 23 by controlling the shaft brake 16 during the transmission gear change operation 14. The synchronization function brakes the gear shaft 23 to zero.

During the transmission gear change operation 14, the gear change function shifts the front-mounted group 17 into neutral prior to the engagement of the transmission gear opposite to the current direction of travel. The gear change function shifts the front-mounted group 17 into neutral after the disengagement of the currently engaged transmission gear and prior to the engagement of the transmission gear opposite to the current direction of travel. During the synchronization for engaging the transmission gear opposite to the current direction of travel, the gear change function shifts the front-mounted group 17 into neutral. For this purpose, the gear change function shifts the front-mounted group 17 into the neutral position. The gear change function shifts the front-mounted group 17 into the neutral position when the main group 11 is shifted into neutral. The gear change function shifts the front-mounted group 17 into the neutral position when all main group shifting units 49, 50, 51 are shifted into the neutral position. In principle, the shifting of the front-mounted group 17 into the neutral position may also be dispensed with during the transmission gear change operation 14. In addition, in principle the gear change function may shift the front-mounted group 17 into neutral only after the synchronization. Furthermore, it is possible in principle for the front-mounted group 17 to lack a defined neutral position, whereby the front-mounted group 17 may be shifted into a position in which it is shifted neither into the low position nor into the high position.

For engaging the transmission gear opposite to the current direction of travel, the gear change function shifts the main group 11 by means of the synchronization function after the synchronization of the main group 11, and after the front-mounted group 17 is shifted into the neutral position. The gear change function engages the transmission gear opposite to the current direction of travel when the front-mounted group 17 is shifted into neutral. The gear change function engages the transmission gear opposite to the current direction of travel only when the main shaft 15 is synchronized by means of the downstream group 12 and the gear shaft 23 is synchronized by means of the shaft brake 16, and when the front-mounted group 17 is shifted into the neutral position. For engaging the transmission gear opposite to the current direction of travel, the gear change function actuates the main group shifting unit 49, 50, 51 associated with the transmission gear opposite to the current direction of travel. The gear change function sets a corresponding shift position of the respective main group shifting unit 49, 50, 51.

For shifting the transmission gear opposite to the current direction of travel, during the transmission gear change operation 14, after the engagement of the transmission gear opposite to the current direction of travel the gear change function downshifts the downstream group 12 and the front-mounted group 17. The gear change function shifts the downstream group 12 and the front-mounted group 17 into the shift positions that were present prior to the transmission gear change operation 14. After the engagement, i.e., after meshing of the transmission gear opposite to the current direction of travel, the gear change function shifts the downstream group 12 from the high position back into the low position, and shifts the front-mounted group 17 from the neutral position into the shift position that was present prior to the request for the transmission gear opposite to the current direction of travel. To terminate the transmission gear change operation 14, the gear change function engages the starting clutch 22, which the gear change function has disengaged prior to shifting the multi-group transmission 10, by means of which the change in travel direction has taken place. The transmission gear change operation 14 extends from a shifting instruction 68 to engagement of the starting clutch 22.

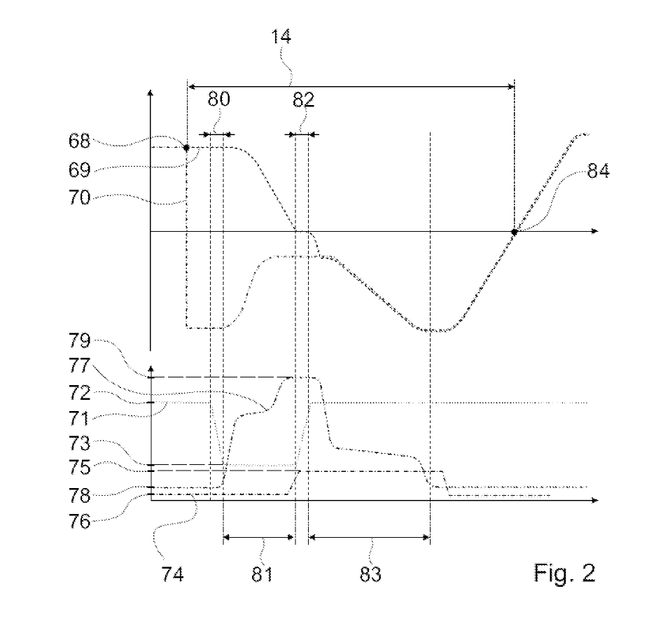

FIG. 2 illustrates a schematic shift sequence during the transmission gear change operation 14, in which the transmission gear is engaged opposite to the current direction of travel. FIG. 2 shows a transmission gear change from a forward transmission gear into a reverse transmission gear during forward travel. In the transmission gear change operation 14 illustrated in FIG. 2, the current direction of travel is provided as the forward direction of travel of the currently engaged transmission gear, and thus, the actual gear as a forward transmission gear, and the transmission gear opposite to the current direction of travel, which is thus directly shifted during travel, is provided as a reverse transmission gear.

A speed curve 69 of the gear shaft 23 and a setpoint speed curve 70 of the main shaft 15 during the transmission gear change operation 14 are illustrated in FIG. 2. The setpoint speed curve 70 represents a speed curve of the main shaft 15 that is converted via a setpoint gear ratio of the main group 11, the setpoint gear ratio representing a gear ratio associated with the target gear, and thus, which is to be shifted. In addition, FIG. 2 illustrates a curve 71 which describes a shift state 72, 73 of the main group 11, the shift state 72 corresponding to a transmission gear which is engaged within the main group 11, and the shift state 73 corresponding to a neutral position of the main group 11 in which the transmission gear is disengaged. A curve 74 illustrated in FIG. 2 describes a shift state 75, 76 of the front-mounted group 17, the shift state 75 corresponding to the neutral position of the front-mounted group 17, and the shift state 76 corresponding to the high position or to the low position of the front-mounted group 17. In addition, FIG. 2 illustrates a curve 77 describing a shift state 78, 79 of the downstream group 12, the shift state 78 corresponding to the low position, and the shift state 79 corresponding to the high position, of the downstream group 12.

The transmission gear change operation 14 is explained below with reference to FIG. 2. Starting from a motor vehicle that is rolling forward and in which a forward transmission gear is shifted, a driver of the motor vehicle requests a reverse transmission gear, and thus a transmission gear opposite to the current direction of travel, by means of a gear selector lever. The driver actuates the gear selector lever during travel, starting from a forward travel stage “D” into a reverse travel stage “R.” The driver requests a change in travel direction. As a result, the control and regulation unit 13 triggers the shifting instruction 68, thus initiating the transmission gear change operation 14 in which the transmission gear opposite to the current direction of travel, and thus the reverse transmission gear, is shifted. Prior to the shifting instruction 68, the speed curve 69 of the gear shaft 23 and the setpoint speed curve 70 of the main shaft 15 have the same algebraic sign, since the gear shaft 23 and the main shaft 15 have a rotational direction that is correct for the forward transmission gear. Due to the shifting instruction 68, a setpoint rotational direction of the main shaft 15 changes due to the fact that the reverse transmission gear has been requested. The algebraic sign of the setpoint speed curve 70 thus changes, since the main shaft 15 still has a rotational direction that is incorrect for the reverse transmission gear. After the shifting instruction 68, the gear change function disengages the starting clutch 22 and shifts the main group 11 in order to disengage the forward transmission gear. The gear change function disengages the forward transmission gear in a disengagement phase 80 and thus shifts the main group 11 into neutral, as is apparent from the curve 71. The disengagement phase 80 is situated within the transmission gear change operation 14. The synchronization function subsequently shifts the downstream group 12. The synchronization function shifts the downstream group 12 from the low position into the high position, as is apparent from the curve 77. The synchronization function shifts the downstream group 12 into the high position in a synchronization phase 81. The synchronization phase 81 is situated within the transmission gear change operation 14. The main group 11 is shifted into neutral within the synchronization phase 81. No transmission gear is engaged within the main group 11 during the synchronization phase 81. Due to the shifting of the downstream group 12 into the high position, the main shaft 15 is braked by the downstream group 12 and is thus synchronized with the gear shaft 23.

In addition, during the synchronization phase 81 the gear shaft 23 is braked to zero by means of the shaft brake 16. For this purpose, the control and regulation unit 13 controls the shaft brake 16 within the synchronization phase 81. During the synchronization phase 81, the main group 11 is synchronized by the downstream group 12 and the shaft brake 16. The gear change function controls the front-mounted group 17 during the synchronization phase 81. During the synchronization phase 81, the gear change function shifts the front-mounted group 17 into neutral before the gear change function engages the transmission gear opposite to the current direction of travel, and thus, the reverse transmission gear. The gear change function shifts the front-mounted group 17 into the neutral position before the synchronization phase 81 ends, and thus, before the gear change function engages the transmission gear opposite to the current direction of travel, and thus, the reverse transmission gear. The gear change function shifts the front-mounted group 17 into neutral in order to engage the reverse transmission gear. The synchronization phase 81 is terminated by the braking of the gear shaft 23 to zero and the complete shifting of the downstream group 12 into the high position.

After the synchronization phase 81, the gear change function shifts the main group 11 in order to engage the transmission gear opposite to the current direction of travel, and thus, the reverse transmission gear. The gear change function engages the reverse transmission gear in an engagement phase 82, as is apparent from the curve 71. The engagement phase 82 is situated within the transmission gear change operation 14. The synchronization phase 81 is situated along the transmission gear change operation 14, between the disengagement phase 80 and the engagement phase 82. The gear change function engages the transmission gear opposite to the current direction of travel, and thus, the reverse transmission gear, when the front-mounted group 17 is shifted into neutral and the downstream group 12 is shifted into the high position. During the engagement phase 82, the front-mounted group 17 is shifted into the neutral position, and the downstream group 12 is shifted into the high position. The curve 77 is constant during the engagement phase 82.

After the engagement of the reverse transmission gear, the gear shaft 23 undergoes a reversal in rotational direction, as a result of which the algebraic sign of the speed curve 69 changes. After the engagement phase 82, and thus after the engagement of the reverse transmission gear, the gear change function downshifts the downstream group 12. In a downshift phase 83 the gear change function shifts the downstream group 12 from the high position back into the low position, as is apparent from the curve 77. The gear change function downshifts the downstream group 12 for shifting the transmission gear opposite to the current direction of travel. The downshift phase 83 is situated within the transmission gear change operation 14. During the downshift phase 83, the front-mounted group 17 is shifted into the neutral position, and the transmission gear opposite to the current direction of travel, and thus, the reverse transmission gear, is engaged. To shift the transmission gear opposite to the current direction of travel, and thus, the reverse transmission gear, the gear change function subsequently downshifts the front-mounted group 17. The gear change function downshifts the front-mounted group 17 after the downshift phase 83 in which the downstream group 12 has been downshifted, from the neutral position into the shift position that was present prior to the shifting instruction 68. The gear change function shifts the front-mounted group 17 after the downstream group 12 is downshifted. The downstream group 12, and then the front-mounted group 17 that is shifted into neutral, are downshifted only after the engagement of the transmission gear opposite to the current direction of travel. After the downstream group 12 and the front-mounted group 17 are downshifted, the gear change function engages the starting clutch 22 in an engagement point 84, as the result of which the reverse transmission gear is shifted and the change in travel direction takes place. Subsequent to the engagement point 84, the speed curve 69 and the setpoint speed curve 70 have a positive algebraic sign, since they each have the correct rotational direction for the reverse transmission gear. The transmission gear change operation 14 is terminated by engaging the starting clutch 22, and thus, subsequent to the engagement point 84.

A numerical example is described below to improve understanding. In the numerical example the drive shaft 21 has a rotational speed n_{engine} of 560 rpm. The rotational speed n_{engine} of the drive shaft 21 is provided as an engine speed. A maximum permissible rotational speed difference H_{ClawDiffmax} between two claws of the claw clutches is 50 rpm.

The currently engaged transmission gear, and thus the actual gear, is provided as a first forward transmission gear. The overall gear ratio i_{gear1} of the multi-group transmission 10 in the first forward transmission gear is 14.93, where the main group gear ratio in the first forward transmission gear i_{HG1} is 2.733, and the downstream group gear ratio i_{Rng1Low} in the first forward transmission gear is 4.4. In the first forward transmission gear, the downstream group 12 is shifted into the low position. This results in a rotational speed of the main shaft 15 of n_{HW}=n_{engine}/i_{gear1}*i_{Rng1Low}=560/14.93*4.4=165 rpm, and a rotational speed of the transmission output shaft 18 of n_{GbOut}=n_{engine}/i_{gear1}=560/14.93=37.5 rpm.

The transmission gear opposite to the direction of travel, and thus the target gear, is provided as the first reverse transmission gear. The overall gear ratio i_{RWgear1} of the multi-group transmission 10 in the first reverse transmission gear is −16.38, where the main group gear ratio i_{HGR1} in the first reverse transmission gear is −3, and the downstream group gear ratio i_{Rng1Low} in the first reverse transmission gear is 4.4. In the first reverse transmission gear, the downstream group 12 is shifted into the low position. The shifting of the downstream group 12 into the high position results in a rotational speed of the main shaft 15 of n_{HW}=n_{Gbout}/i_{RngHi}=37.5*1=37.5 rpm. A setpoint rotational speed n_{VGW,setpoint} of the gear shaft 23 for the first reverse transmission gear is n_{HW}*i_{HGR1}=37.5*(−3)=−113 rpm. An actual rotational speed n_{VGW,actual1} of the gear shaft 23 is n_{HW}*i_{HG1}=165*2.733=451 rpm. The actual rotational speed of the gear shaft 23 is reduced to zero by controlling the shaft brake 16. A rotational speed difference n_{ClawDiffMesh} between two claws of the claw clutch associated with the first reverse transmission gear is thus n_{HW}=37.5 rpm. For forward travel, the first reverse transmission gear is directly shiftable from the first forward transmission gear, since the rotational speed difference n_{ClawDiffMesh} between two claws of the claw clutch associated with the first reverse transmission gear is smaller than the maximum permissible rotational speed difference n_{ClawDiffMax} between two claws.

If the shifting of the downstream group 12 for engaging the first reverse transmission gear were dispensed with, this would result in a rotational speed of the main shaft 15 of n_{HW}=n_{Gbout}/i_{RngLow}=37.5*4.4=165 rpm, since the downstream group 12 is shifted into the low position. A rotational speed difference between two claws of the claw clutch associated with the first reverse transmission gear, n_{ClawDiffMesh}=n_{HW}, would then be 165 rpm. Thus, for forward travel the first reverse transmission gear is not directly shiftable from the first forward transmission gear, since the rotational speed difference n_{ClawDiffMesh} between two claws of the claw clutch associated with the first reverse transmission gear is larger than the maximum permissible rotational speed difference n_{ClawDiffMax} between two claws.

Alternatively, instead of shifting the downstream group 12 into the high position, the synchronization function may shift the downstream group 12 into the neutral position during the transmission gear change operation 14. The synchronization function is explained below, which during the transmission gear change operation 14 shifts the downstream group 12 into the neutral position in order to engage the transmission gear opposite to the current direction of travel. The synchronization function shifts the downstream group 12 into the neutral position in order to brake the main shaft 15. For synchronizing the main group 11, the synchronization function shifts the downstream group 12 from the low position into the neutral position. The synchronization function sets the neutral position of the downstream group shifting unit 60. For synchronizing the main group 11, during the transmission gear change operation 14 the synchronization function, starting from the first shift position of the downstream group shifting unit 60, sets the neutral position of the downstream group shifting unit 60. Thus, after the engagement of the transmission gear opposite to the current direction of travel, the gear change function shifts the downstream group 12 from the neutral position into the low position. In the transmission gear change operation 14 in which the synchronization function shifts the downstream group 12 into the neutral position, the gear change function may engage the actual gear. The synchronization function shifts the downstream group 12 into the neutral position when the actual gear is engaged. The synchronization function then controls the shaft brake 16 with the actual gear engaged, and thus brakes the gear shaft 23 and the main shaft 15. The gear change function shifts the main group 11 after the gear shaft 23 and the main shaft 15 are braked to zero or essentially to zero. After the braking, the gear change function disengages the actual gear by shifting the main group 11, and then engages the transmission gear opposite to the current direction of travel by shifting the main group 11. After the engagement of the transmission gear opposite to the current direction of travel, the gear change function downshifts the downstream group 12 into the low position.

Whether the synchronization function shifts the downstream group 12 into the high position or into the neutral position for synchronization of the main group 11 is a function, for example, of at least one operating parameter and/or the transmission gear opposite to the current direction of travel. In principle, it is conceivable for the synchronization function to have only one of the two synchronization strategies; i.e., the downstream group 12 shifts either into the high position or into the neutral position, regardless of which operating parameters are present, and/or which transmission gear opposite to the current direction of travel is shifted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A motor vehicle drive train device, comprising:
a multi-group transmission, which includes a main group configured to provide at least one forward transmission gear and at least one reverse transmission gear, and a downstream group downstream from the main group; and
a control/regulation unit having a gear change function configured to shift the main group from a forward transmission gear into a reverse transmission gear at least in one transmission gear change operation to engage a first transmission gear opposite to the current direction of travel,
wherein the control/regulation unit has a synchronization function configured to shift shifting the downstream group into a high position to brake a main shaft of the main group to engage the first transmission gear of the main group opposite to the current direction of travel.

11. The motor vehicle drive train device of claim 10, wherein the multi-group transmission has at least one shaft brake, and the synchronization function is configured to actuate the shaft brake in to engage the transmission gear opposite to the current direction of travel.

12. The motor vehicle drive train device of claim 10, wherein the multi-group transmission has a front-mounted group, and the gear change function is configured to shift the front-mounted group into neutral during the transmission gear change operation, prior to the engagement of the transmission gear.

13. A motor vehicle drive train device of claim 10, wherein the gear change function is configured to downshift at least the downstream group during the transmission gear change operation, after the engagement of the transmission gear.

14. The motor vehicle drive train device of claim 10, further comprising:
a rotational speed sensor configured to sense a rotational direction, wherein the rotational speed sensor is in communicating connection with the control/regulation unit in order to recognize the current direction of travel or to adjust to a desired direction of travel.

15. The motor vehicle drive train device of claim 10, wherein the downstream group has a low position, and the synchronization function is configured to shift the downstream group from the low position into the high position in order to engage the transmission gear opposite to the current direction of travel.

16. The motor vehicle drive train device of claim 10, wherein the synchronization function is configured to shift the downstream group into neutral in order to engage the transmission gear opposite to the current direction of travel.

17. The motor vehicle drive train device of claim 10, wherein the main group is an unsynchronized claw clutch transmission group.

18. A method for engaging a transmission gear opposite a current direction of travel in a multi-group transmission of a motor vehicle drive train device comprising a multi-group transmission, which includes a main group configured to provide at least one forward transmission gear and at least one reverse transmission gear, and a downstream group downstream from the main group and a control/regulation unit having a gear change function configured to shift the main group from a forward transmission gear into a reverse transmission gear at least in one transmission gear change operation to engage a first transmission gear opposite to the current direction of travel, the method comprising:
performing at least in one transmission gear change operation by shifting the main group from the forward transmission gear into the reverse transmission gear to engage the transmission gear opposite to the current direction of travel; and
shifting the downstream group during the transmission gear change operation to engage the transmission gear of the main group opposite to the current direction of travel.

19. The method of claim 18, wherein the following steps which are carried out in the stated sequence in succession:
1) disengaging the forward transmission gear and thus shifting the main group into neutral,
2) shifting the downstream group into a high position, the main group remaining in neutral, and braking a gear shaft to zero by means of a shaft brake and shifting a front-mounted group into neutral,
3) shifting the main group for engaging the reverse transmission gear,
4) shifting the downstream group back into a low position.
